(19) United States
(12) Patent Application Publication
(10) Pub. No.: US 2010/0308112 A1
(43) Pub. Date: Dec. 9, 2010

(54) STORAGE DEVICE WITH DISPLAY MODULE

(75) Inventor: Chun-Keong Chew, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/556,543

(22) Filed: Sep. 9, 2009

(30) Foreign Application Priority Data
Jun. 3, 2009 (CN) 200910302890.0

(51) Int. Cl. G06K 7/00

(52) U.S. Cl. 235/436

(57) ABSTRACT

A storage device includes a storage module, a processor, an enclosure and a display module. The processor is capable of acquiring a storage status of the storage module. The display module is capable of displaying the storage status.

### BACKGROUND

1. Technical Field

The disclosure generally relates to storage devices, particularly to a storage device with a display module for displaying a storage status.

2. Description of Related Art

Usually, portable data storage devices, such as USB flash drives are widely used for data transmitting. These kinds of data storage devices have a finite volume. The amount of free space of the data storage device available at any given time cannot be determined without inserting the data storage device into a computer. So, it is need to improve the data storage device.

### BRIEF DESCRIPTION OF THE DRAWINGS

FIG. 1 is a block diagram showing components of a storage device.

FIG. 2 is a schematic view of a storage device according to a first embodiment.

FIG. 3 is a schematic view of a storage device according to a second embodiment.

FIG. 4 is a schematic view of a storage device according to a third embodiment.

### DETAILED DESCRIPTION

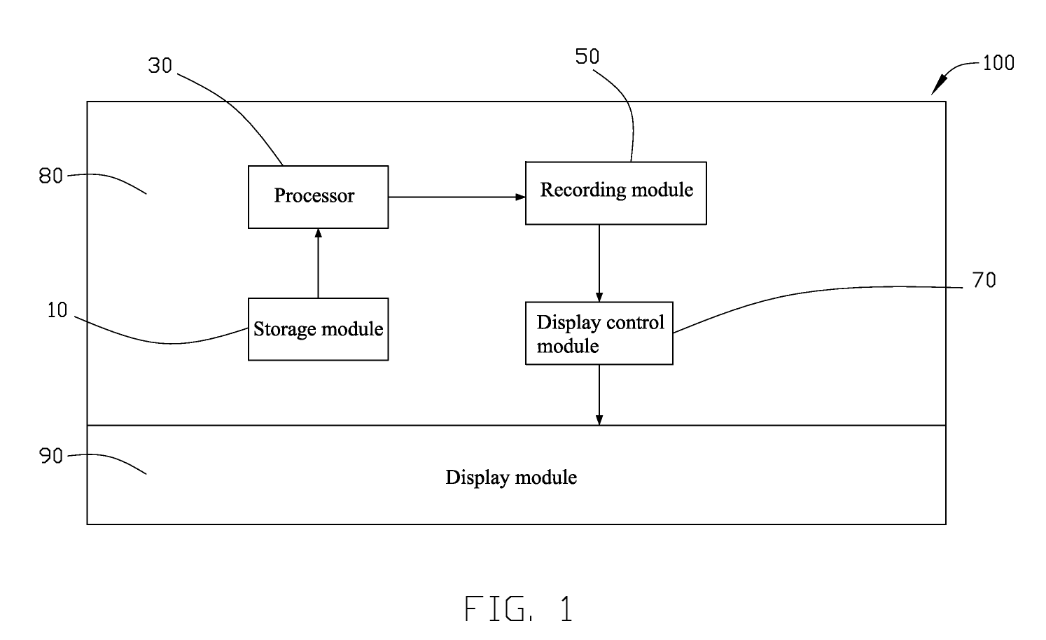

Referring to FIG. 1, a storage device 100 includes an enclosure 80, a storage module 10, a processor 30, a recording module 50, a display control module 70, and a display module 90. The enclosure 80 is a casing of the storage device 100. The display module 90 is located outside of the enclosure 80. The storage module 10, the processor 30, and the recording module 50 are located inside the enclosure 80. The storage device 100 can be a portable USB flash drive or other portable storage device.

The storage module 10 entire storage volume is for storing data files. The processor 30 can acquire or calculate a storage status of the storage module 10. The storage status includes at least one of a used volume of the storage module 100, a free volume of the storage module 100, and a used volume percentage. The recording module 50 can record the storage status from the processor 30 when the storage module 10 is working. The display control module 70 is used for driving the display module 90 to display the storage status.

The display module 90 is a display device, such as a liquid crystal display, a light-emitting diode display, and so on. The display module 90 can display the storage status when supplied with power from a host device or a battery. For example, when the storage device is inserted into a computer, power is supplied from the computer. The display module 90 can update the storage state of the storage device 100 when the storage module 10 is connected to a computer. When the storage device 100 is removed from the computer, the power can come from the battery in the storage device 100, so a user can directly acquire the storage status of the storage device 100 without having to access the storage device 100 and reading the storage status by using the computer.

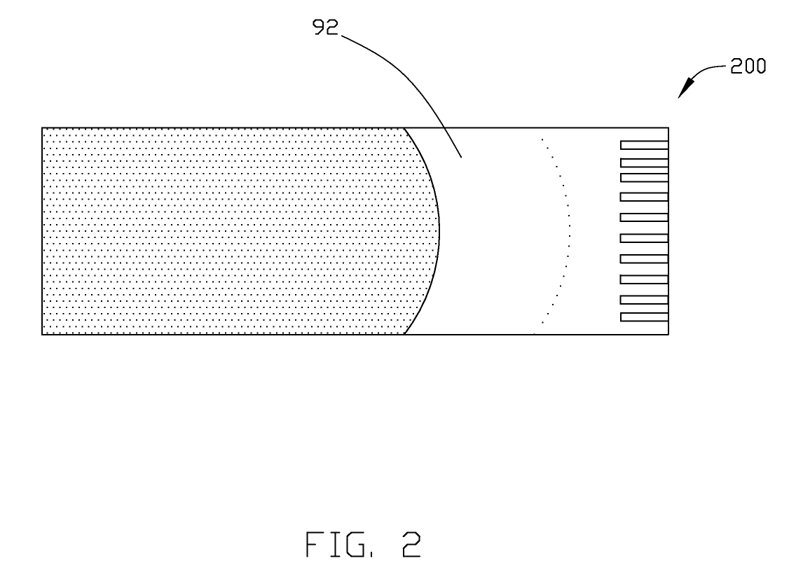

Referring to FIG. 2, in a first embodiment, a storage device 200 includes a display module 92. The display module 92 has a bar-shaped display area for displaying a whole storage volume. A used volume and a free volume is displayed proportionally on the display area using different colors.

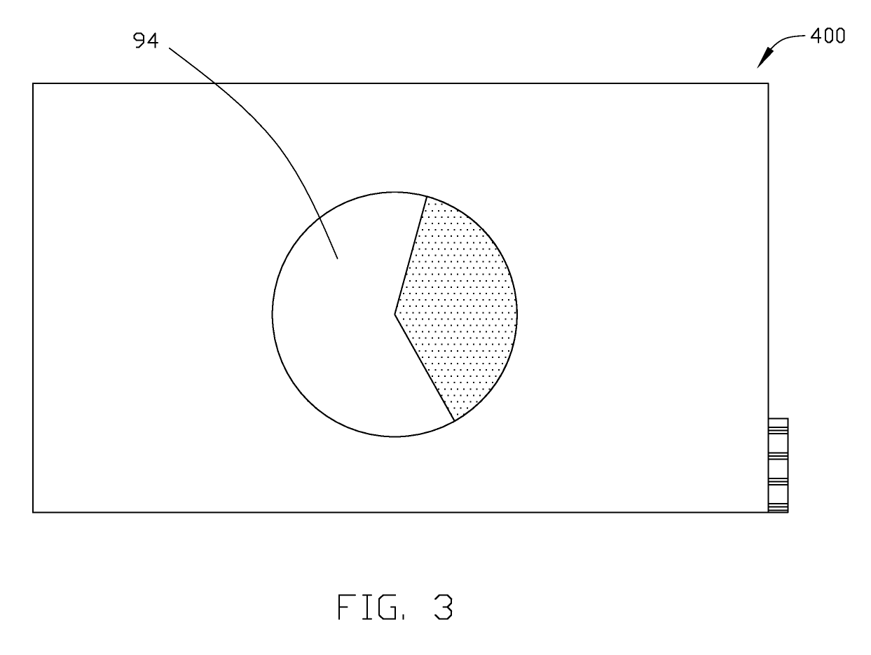

Referring to FIG. 3, in a second embodiment, a storage device 400 includes a display module 94. The display module 92 has a pie-shaped display area for displaying the whole storage volume. A used volume and a free volume are displayed proportionally on the display area using different colors.

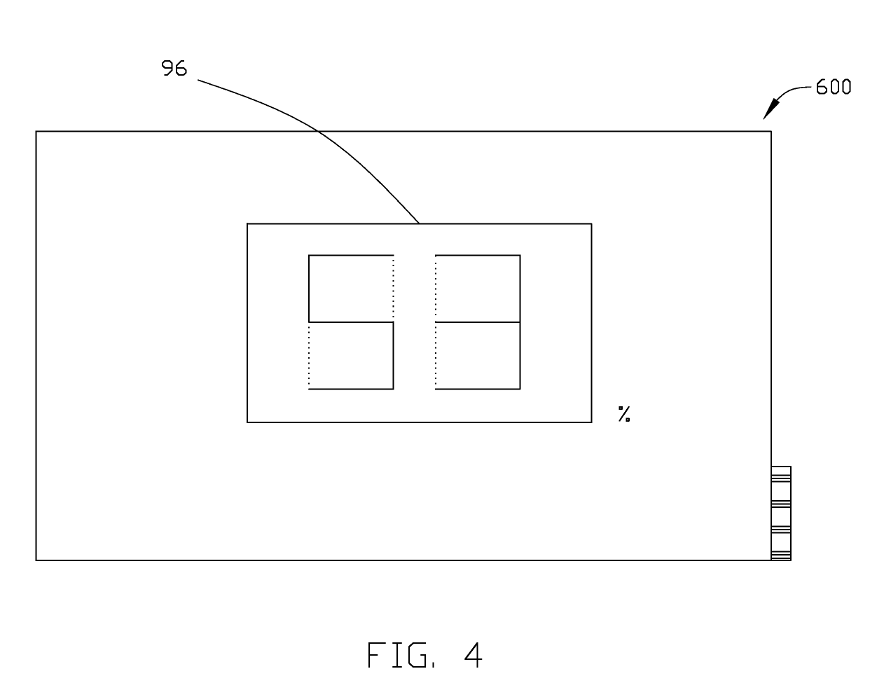

Referring to FIG. 4, in a third embodiment, a storage device 600 includes a display module 96. The used volume percentage is directly displayed on the display module 96 as a percentage number.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A storage device, comprising:
a storage module;
a processor capable of acquiring a storage status of the storage module;
an enclosure; and
a display module capable of displaying the storage status outside the enclosure;
wherein the storage status comprises an entire storage volume and a used volume of the storage module; the display module has a bar-shaped display area for displaying the entire storage volume, the used volume is displayed on proportionally to the bar-shaped display area, and bar-shaped display area extends to cover an entire surface of the enclosure.

2. The storage device of the claim 1 further comprising a recording module capable of recording the storage status when the storage module is activated.

3. The storage device of the claim 1 further comprising a display control module for driving the display module to display the used volume.

4. The storage device of the claim 1, wherein the display module is a liquid crystal display.

5. The storage device of the claim 1, wherein the display module is a light-emitting diode display.

6-8. (canceled)

9. The storage device of the claim 1, wherein the storage device is a portable USB flash drive.

10. A storage device, comprising:
a storage module having a whole storage volume;
a processor capable of calculating a used volume percentage of a used volume versus the whole storage volume;
an enclosure; and
a display module capable of displaying the used volume percentage, the display module is outside the enclosure, wherein the display module covers an entire surface of the enclosure.

11. The storage device of the claim 10 further comprising a recording module capable of recording the storage status when the storage module works.

12. The storage device of the claim 10 further comprising a display control module for driving the display module to display the used volume percentage.

13. The storage device of the claim 10, wherein the display module is a liquid crystal display.

14. The storage device of the claim 10, wherein the display module is a light-emitting diode display.

15. (canceled)

16. The storage device of the claim 10, wherein the storage device is a portable USB flash drive.

17. The storage device of the claim 10, wherein the storage status comprises an entire storage volume and a used volume of the storage module; the display module has a bar-shaped display area for displaying the whole storage volume, the used volume is displayed on proportionally to the bar-shaped display area.
